(19) United States
(12) Patent Application Publication
(10) Pub. No.: US 2006/0093114 A1
(43) Pub. Date: May 4, 2006

(54) Multi-status key panel

(75) Inventor: Ko-Chien Kan, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: FIH CO., LTD, Shindian City (TW)

(21) Appl. No.: 11/247,899

(22) Filed: Oct. 11, 2005

(30) Foreign Application Priority Data
Oct. 8, 2004 (CN) 200410051828.6

(51) Int. Cl. H04M 1/00

(52) U.S. Cl. 379/164

(57) ABSTRACT

A multi-status key panel (10) includes a panel (12) which defines at least one hole (14) and at least one multi-status key (20) which includes a key top (21). The key top has a sign area (22) with at least one sign marked on a surface thereof and a multi-status connector (25) provided at a bottom of the key top. The multi-status connector is for connecting with a PCB (30) (printed circuit board). The operation of the multi-status key panel is convenient and easy. In addition, the layout of each key can reduce the space limitations, so the multi-status key panel can be used in desirable miniaturization of devices such as mobile phones.

### FIELD OF THE INVENTION

The present invention relates to key panels and keyboards for data entry or device control, and more particularly to a multi-status key panel.

### GENERAL BACKGROUND

Presently, a conventional mobile phone keypad has ten numbered keys, an asterisk key and a pound sign key. The letters of the alphabet are listed in groups of three on eight of the numbered keys. Entering numerals is performed by simply depressing the indicated keys in turn. However, for entering any given letter of the alphabet, a series of keystrokes is required. This method is not always accepted or understood by members of the public. In telecommunication applications such as voice mail directory searches or in stock purchasing using an electronic broker, a unique interpretation of alpha(bet) data codes is often necessary. Users are prone to commit errors in alpha data entry using the conventional keypad, which is a common and frustrating occurrence known to many. Thus there have been frequent calls for a simple, relatively error free method of alpha data and numeric data entry.

For the manufacturers of remote controllers, calculators, games, mobile phones and similar electronic communication and entertainment equipment, the space required for adequate data entry with conventional keys presents a continuing problem. A full range of alphabet keys generally requires much space, and hinders miniaturization of the device.

Many patents that address the alpha-numeric keypad problem have been issued. However, there is still no known system for keypad/keyboard data entry that provides for error-free data without complex structures or operation. Similarly, there is no known system that allows for practical miniaturization of a keypad/keyboard while permitting any desired number of distinct, single key data entries in a simple “hands on” format.

For example, in U.S. Pat. No. 4,918,721 to Hashimoto, and in U.S. Pat. No. 4,825,464 to Wen, the alpha-numeric keypad data entry problem was solved. However, the solution may be considered to be too elaborate and cumbersome for general use. The use of keypads with multi-directional keys is taught in a number of patents, and this is an approach that promises much in the drive toward keyboard miniaturization. Among these patents is U.S. Pat. No. 5,528,235 to Lin et al. Referring to FIG. 4, Lin et al disclose a multi-status key panel 100 that is capable of one-to-one correspondence between each key status and a pre-assigned signal or state. This is achieved by using a key 110 having one horizontal facet 111 and four inclined facets 112, and mounting the key 110 on a spring so that it can rock in four orthogonal directions and downward. Thus each key 110 in effect acts as five different keys, with each facet's directional push entering a different piece of data. No description or claim is given by Lin et al for the system of the multi-status key panel 100 to convert and transmit the input data in usable form.

To date, it is believed that the Lin et al invention and similar devices have not succeeded in the commercial market for telephonic communication, remote controllers, and similar equipment. Various reasons are mooted by industry sources for the failure to adopt these inventive devices. Such reasons include the likelihood of finger tactile errors in data entry using multi-faceted keys such as those described by Lin et al; and the complexity and expensive of manufacturing the device, particularly the keys thereof.

What is needed, therefore, is a multi-status key panel which is simple, compact, and relatively error-free for telecommunication equipment, small computers, miniaturized controllers, and the like.

### SUMMARY

In a preferred embodiment herein, a multi-status key panel includes a panel defining at least one key hole and at least one multi-status key, which includes a key top. The key top has a sign area with at least one sign marked on a surface thereof, a multi-status connector is provided at a bottom of the key top, and the multi-status connector is for connecting with a PCB (printed circuit board).

Because each key of the present invention is a multi-status key, the present invention is capable of a one-to-one correspondence between each key status and a pre-assigned signal or state by operating the multi-status key in regarding direction. Therefore, the operation of the multi-status key panel is convenient and easy. In addition, the layout of each key can reduce the space limitations, so the multi-status key panel can be used in desirable miniaturization of device such as mobile phone.

Other advantages and novel features will become more apparent from the following detailed description of preferred embodiments when taken in conjunction with the accompanying drawings, in which:

### BRIEF DESCRIPTION OF THE DRAWINGS

FIG. 1 is a top plan view of a multi-status key panel in accordance with a preferred embodiment of the present invention;

FIG. 2 is an exploded, isometric view of a multi-status key of the multi-status key panel of FIG. 1;

FIG. 3 is an assembled view of FIG. 2; and

FIG. 4 is an isometric view of a conventional multi-status key panel.

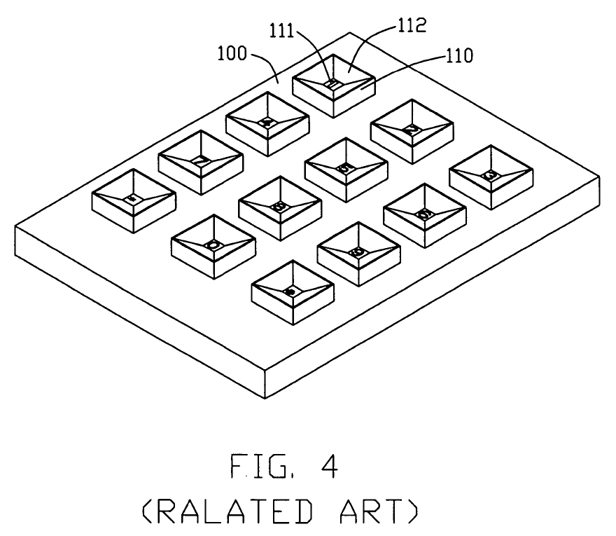

### DETAILED DESCRIPTION OF PREFERRED EMBODIMENTS

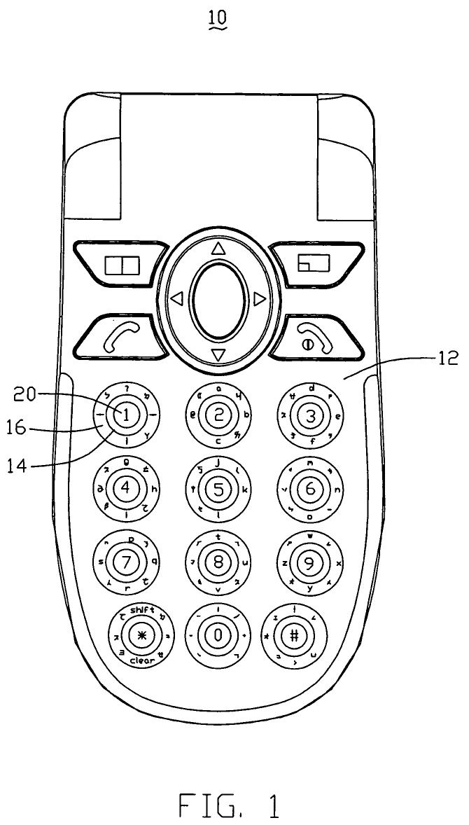

Referring to FIG. 1, in a preferred embodiment of the present invention, a multi-status key panel 10 for a mobile phone includes a panel 12 and plural multi-status keys 20. The panel 12 defines plural key holes 14, for the multi-status keys 20 to protrude out through. The multi-status keys 20 are inserted through the holes 14 from an underside of the panel 12, and protrude from the opposite top side of the panel 12 so that the multi-status keys 20 can be pressed by a user. Each multi-status key 20 has at least one number from 0 to 9, or one of a “*” and a “#” sign, marked in a middle thereof.

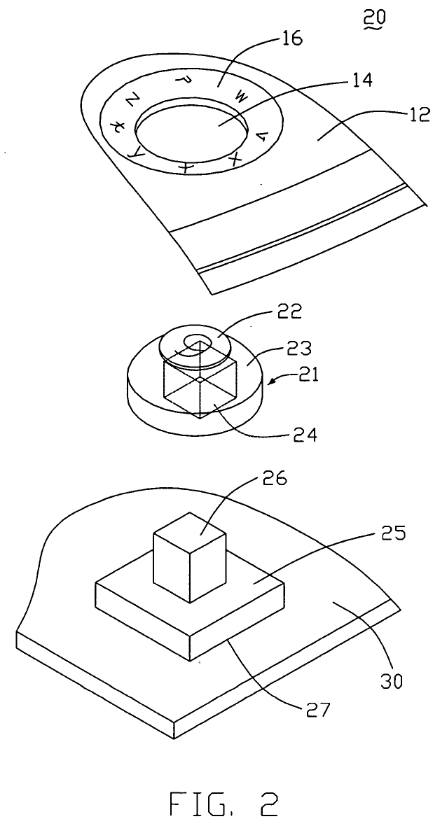

Referring to FIG. 2, each multi-status key 20 includes a key top 21 and a multi-status connector 25. The multi-status connector 25 is provided below the key top 21. The key top 21 has a bottom (not shown) engaging with a top of the multi-status connector 25. The multi-status connector 25 also has a bottom (not shown) connecting with a PCB 30 (printing circuit board) of a mobile phone.

The key top 21 is for the user to touch directly. The key top 21 is like a round lid which has a partially hemispherical surface. A top of the key top 21 defines a flat key area 22 with a number or a sign marked thereon. The illustrated key area has the number ‘9’ marked thereon, and the key areas 22 of the various key tops 21 have different numbers or signs marked thereon. A pressing area 23 is defined around the key area 22. In the illustrated embodiment, the key area 22 is slightly raised above a top of the pressing area 23. In an alternative embodiment, the key area 22 links with the pressing area 23 smoothly. The key top 21 defines a socket 24 in a bottom thereof.

An annular sign area 16 is provided on the panel 12 around each hole 14. The sign area 16 slopes down at an oblique angle from a periphery thereof to the hole 14, and surrounds the multi-status key 20. The sign area 16 has several signs spaced apart at regular intervals. In the illustrated embodiment, there are eight signs. The signs may be letters of the alphabet, instruction signs, or other signs.

The multi-status connector 25 is a conventional connector and has a rocker 26 extending up from a middle thereof. The rocker 26 engages in the socket 24 of the key top 21. The multi-status connector 25 has a touch end 27 at a bottom thereof. The touch end 27 has a central plug (not shown) corresponding to the key area 22, and eight surrounding plugs (not shown) distributed in eight directions corresponding to signs of the sign area 16. The rocker 26 can be moved vertically or inclined in any of the eight directions. When the rocker 26 is moved, one plug of the touch end 27 can connect with the PCB 30 to send an electronic signal to the mobile phone.

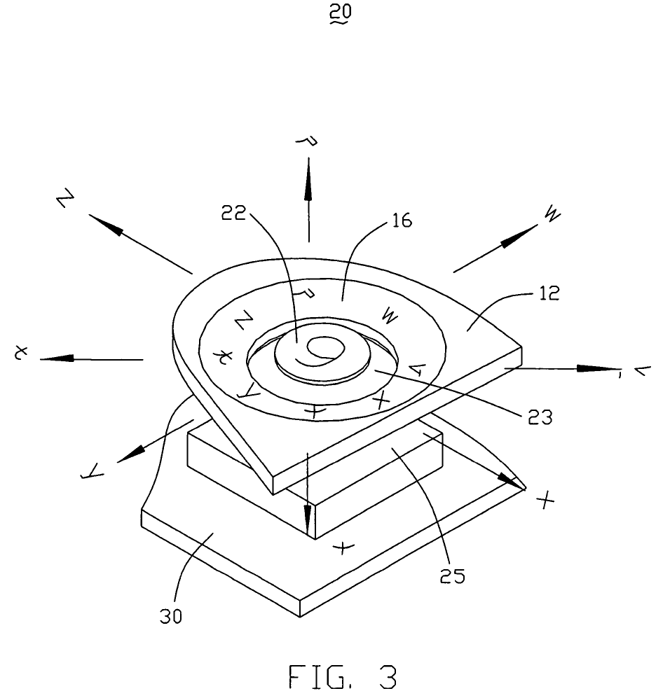

Referring to FIG. 3, in use of any multi-status key 20 of the multi-status key panel 10, if the key area 22 of the key top 21 is pressed vertically, the key top 21 drives the rocker 26 to move vertically, and one plug of the touch end 27 connects with the PCB 30. Thus a pre-assigned number on the multi-status key 20 is inputted to the PCB 30. If a pre-assigned sign of the sign area 16 needs to be inputted, the pressing area 23 is pressed vertically. This makes the rocker 26 incline toward one of the pre-assigned signs, and one of the corresponding surrounding plugs of the sign area 16 connects with the PCB 30. In this way, information can be easily inputted to the PCB 30 via the multi-status key panel 10.

It is believed that the embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

I claim:

1. A multi-status key panel comprising:
a panel defining at least one key hole; and
at least one multi-status key, which includes a key top;
wherein the key top has a sign area with at least one sign marked on a surface thereof, a multi-status connector is provided at a bottom of the key top, and the multi-status connector is for connecting with a PCB (printed circuit board).

2. The multi-status key panel as claimed in claim 1, wherein the multi-status connector has a rocker in a middle thereof, the rocker can be moved vertically, and the rocker can also be pivotably moved about a middle thereof.

3. The multi-status key panel as claimed in claim 1, wherein the key top comprises a partially hemispherical portion, and a central top portion surrounded by the partially hemispherical portion.

4. The multi-status key panel as claimed in claim 3, wherein the top portion has a number or a sign marked thereon.

5. The multi-status key panel as claimed in claim 4, wherein the at least one multi-status key is a plurality of multi-status keys, and the top portions of the key tops have different numbers or signs marked thereon.

6. The multi-status key panel as claimed in claim 2, wherein the key top defines a socket in the bottom thereof, and the socket engagingly receives the top of the rocker.

7. The multi-status key panel as claimed in claim 1, wherein at least one sign area surrounds the multi-status key, and the sign area slopes down at an oblique angle to the multi-status key.

8. The multi-status key panel as claimed in claim 7, wherein the sign area has a plurality of signs spaced apart at intervals, and the signs are letters of instruction signs.

9. The multi-status key panel as claimed in claim 8, wherein the signs comprise items selected from the group consisting of letters of the alphabet and instruction signs.

10. The multi-status key panel as claimed in claim 1, wherein the at least one sign is selected from the group consisting of any number from 0 to 9, a “*” sign, and a “#” sign.

11. The multi-status key panel as claimed in claim 1, wherein the multi-status key can be operated in at least eight directions.

12. A system for multiple data input comprising:
a panel defining a user-accessible side, at least one hole defined on said user-accessible side and extending in said panel; and
a key movably extending in said at least one hole and spaced from inner walls of said at least one hole so as to expose a top thereof out of said user-accessible side, said key movable spatially from said inner walls of said at least one hole and straightly along said at least one hole to generate input of a first kind of data, and swayable toward said inner walls of said at least one hole along at least two directions substantially parallel to said user-accessible side by a user-providing force applied on said top of said key from said inner walls of said at least one hole toward said key to generate input of a different kind of data from said first kind of data corresponding to each of said at least two directions.

13. The system as claimed in claim 12, wherein said first kind of data is a numerical data including any number from 0 to 9, a “*” sign, and a “#” sign.

14. The system as claimed in claim 12, wherein said different kind of data is a selective data of alphabet and instruction signs.

15. A method for multiple data input comprising the steps of:
preparing a panel defining a user-accessible side with at least one hole formed thereon and extending in said panel;
installing a key in said at least one hole to have said key spaced from inner walls of said at least one hole so as to expose a top thereof out of said user-accessible side; and
allowing said key movable along at least three directions in said at least one hole to generate different data inputs from one another, wherein all of said at least three directions are parallel to said user-accessible side except one direction thereof, by means of user-applying forces on said top of said key from said inner walls of said at least one hole toward said key and a user-applying force on said top of said key along said one except direction of said at least three directions.

16. The method as claimed in claim 15, wherein movement of said key along said one except direction of said at least three directions leads to input of numerical data including any number from 0 to 9, a “*” sign, and a “#” sign.

17. The method as claimed in claim 15, wherein movement of said key along each of all other directions of said at least three directions leads to input of a selective data of alphabet and instruction signs.
